(19) United States
(12) Patent Application Publication
(10) Pub. No.: US 2015/0122797 A1
(43) Pub. Date: May 7, 2015

(54) Isothermal Cooking Plate Apparatus, System, and Method of Manufacture and Use

(71) Applicant: Eggers & Associates, Inc., Amelia Island, FL (US)

(72) Inventor: Philip E. Eggers, Amelia Island, FL (US)

(73) Assignee: Eggers & Associates, Inc., Amelia Island, FL (US)

(21) Appl. No.: 14/526,570

(22) Filed: Oct. 29, 2014

Related U.S. Application Data
(60) Provisional application No. 61/899,415, filed on Nov. 4, 2013.

(51) Int. Cl. H05B 3/68; H05B 1/02

(52) U.S. Cl. CPC H05B 3/688; H05B 1/0266
USPC 219/450.1; 219/549; 29/825

(57) ABSTRACT

An isothermal cooking plate assembly is formed from a first plate of high thermal conductivity material having a back surface and an oppositely disposed top cooking surface. One or more heater circuit assemblies are disposed on the first plate back surface for forming a composite having a back surface. A controller is in electrical connection with the heater circuit assemblies for controlling temperature of the first plate of high thermal conductivity material. The first plate can be substantially pure one or more aluminum, substantially pure copper, or aluminum nitride. The first plate can be a laminate formed from a clad bottom metal layer and clad top cooking surface metal layer, where the clad layers formed from the same material and having about the same thickness. The clad material can be austenitic stainless steel. A second plate of low thermal conductivity material can be attached to the composite back surface.

### CROSS-REFERENCE TO RELATED APPLICATIONS

This application claims benefit of provisional application Ser. No. 61/899,415 filed on Nov. 4, 2013.

### STATEMENT REGARDING FEDERALLY SPONSORED RESEARCH

Not applicable.

### BACKGROUND

The accurate temperature control of large isothermal cooking plates is required for certain food processing wherein variable rates of heat dissipation exist across the extent of the first plate. Some applications also require that such first plates can be raised from room temperature to the desired isothermal operating temperature within a very brief time period, as short as several tens of seconds. Furthermore, some applications require that the first plate surface be suitable and safe for contact with objects, such as liquid or solid foods, and be resistant to damage by exposure to liquids and mechanical damage by contacting objects such as knives and other cooking implements. In addition, there is a need to provide a cooking surface comprising a non-stick coating to minimize the need for supplemental cooking liquids (e.g., cooking oils) and minimize the effort required to clean adhered food residue from the cooking surface following prior cooking processes.

Accordingly, there is a need to provide a durable first plate capable of delivering sufficient thermal energy to maintain an isothermal temperature distribution across the extent of the first plate surface while maintaining a pre-selected temperature in the presence of rapidly and widely varying heat dissipation rates across the surface of the first plate.

In addition, there is a need to simplify the complexity of the first plate construction to increase its reliability and reduce its manufacturing costs to enable its use in high-volume cooking applications and enable rapid and convenient replacement of only the first plate assembly in the event of deterioration and loss of release characteristics of the non-stick coating, failure of the resistive heating element and/or failure of temperature sensor.

### BRIEF SUMMARY

The present disclosure is addressed to designs for an isothermal cooking plate, controller, griddle enclosure, and the method of manufacture of isothermal cooking plate assembly and griddle system. The first plate of high thermal conductivity material advantageously may be aluminum, copper, or aluminum nitride. The first plate of high thermal conductivity material may optionally be roll bonded on either side with a cladding layer, for instance, formed of equal-thickness austenitic stainless steel, such as a type 304. Thus, a clad version of first plate of high thermal conductivity material is symmetrical and, notwithstanding, differences of thermal coefficients of expansion, the laminar component will not warp, for example, during intended operation at elevated temperatures. The corrosion-resistant and durable cladding (e.g., austenitic stainless steel) may be applied by roll bonding, plasma spray coating or vapor deposition processes. In addition, the hardness, wear resistance, corrosion resistance, and lubricity of the exterior surface of the stainless steel cladding may be further improved using metal finishing processes such as MEDCOAT 2000™ provided by the Electrolyzing Corporation of Ohio (Cleveland, Ohio). Alternatively, the cooking surface of the first plate of high thermal conductivity material may coated with a corrosion resistant and durable surface layer applied by electroplating or electroless plating processes (e.g., nickel or chrome plated surface coating).

The first plate of high thermal conductivity material of the present disclosure may advantageously incorporate a non-stick coating on its top-cooking surface to minimize the need for supplemental cooking liquids (e.g., cooking oils) and minimize the effort required to clean adhered food residue from the top cooking surface following prior cooking processes.

Thermal energy is supplied to the first plate on the side opposite its food heating side by a flexible substrate heater circuit assembly incorporating one or more resistor heating segments having associated circuit leads extending to an array of resistive heating element terminals located on the side opposite its food heating side. Two manufacturing methods for the flexible substrate heater circuit assembly are described. In the first manufacturing method, the heater circuit and lead circuit is entirely contained on one surface of a polyimide or other suitable flexible plastic substrate wherein the heater circuit is accessed by exposed contact tab terminals located on the polyimide substrate that extend from the first plate of high thermal conductivity material. The metallic heater circuit portions of the flexible circuits are applied to the back surface of the first plate opposite top cooking surface using a thermally conductive, electrically insulative adhesive.

In the second heater manufacturing method involving a first plate of thermally conductive material that is metallic, a first electrically insulative layer is screen printed and cured or fired on the back surface of the first plate opposite its top cooking surface followed by the selective screen printing and curing or firing of [a] a second electrically resistive heating element layer (utilizing screen printable inks of higher electrical resistivity) on the first electrically insulative layer and [b] a third electrically conductive lead and contact pad pattern layer (utilizing screen printable inks of lower electrical resistivity) in electrical communication with the heating element. Alternatively, in the second heater manufacturing method involving a first plate of thermally conductive material that is electrically insulative (e.g., aluminum nitride), a first electrically resistive layer is screen printed and cured or fired on the back surface of the first plate opposite its top cooking surface followed by the screen printing and curing or firing of [a] a second electrically conductive lead and contact pad pattern (utilizing screen printable inks of lower electrical resistivity) in electrical communication with the heating element.

The thickness of the first plate of high thermal conductivity material of the isothermal cooking plate assembly is optimized to [a] provide the thermal conductance required to maintain a uniform temperature across the entire surface of the first plate in the presence of varying heat dissipation rates across the entire surface of the first plate while [b] minimizing the time required to heat up the first plate to the user-selected set-point temperature. In both manufacturing approaches, the thermal conductance between the resistive heating element and the first plate is selected to be sufficiently high to enable the first plate to be heated to the selected set point temperature within several tens of seconds. By way of example, the first plate of the present disclosure can be heated from room temperature to 150 C within about 15 or 30 seconds for resistive heating elements energized with a maximum applied alternating current of 20 amps at an applied line voltage of 220 volts or 115 volts, respectively.

The operating temperature of the isothermal cooking plate of the present disclosure may be fixed or operator selectable and controlled with one of several feedback control system designs. One controller design uses one or more temperature sensors (e.g., thermocouples) attached at one or more locations on the first plate to regulate the application of power to one or more heater segments to maintain the pre-selected isothermal operating temperature or to enable the operator to achieve isothermal process heating at various operator selected cooking temperatures. This controller design is referred to hereinafter as temperature-sensor based feedback control. An alternative controller design makes use of the characteristic of the high temperature coefficient of resistance of pure metals to effect resistance feedback control of the temperature of the attached heater segment component.

For example, one or more constantan-on-polyimide flexible heater circuits can be thermally attached to the first plate using the aforementioned high thermal conductance and electrically insulative adhesive layer. Constantan is a copper-nickel alloy, usually consisting of 55% copper and 45% nickel. By measuring the first plate temperature using one or more temperature sensors, the power delivered to each heater circuit can be controlled by a controller to maintain the first plate at the user-selected set-point temperature.

As an alternative to the constantan-on-polyimide resistive heating element design described above, thick film printing processes may be used to first print a thermally conductive, electrically insulative layer on the first surface of the first plate. Following curing of this dielectric layer, the resistive heating element heater traces and lead pattern is screen printed on the dielectric layer using electrically conductive thick film ink and cured. By way of example, high thermal expansion glass-based dielectric layer and heater/lead thick-film printable materials may be used that match the thermal expansion of the first plate of high thermal conductivity material. In this regard, see U.S. Pat. No. 5,308,311, entitled Electrically Heated Surgical Blade and Method of Making. In yet another alternative method of manufacturing the resistive heating element, a polymer-based dielectric layer and polymer-based resistive heating element heater traces and lead pattern may be screen printed directly on the first plate of high thermal conductivity material. Alternatively, the first plate of high thermal conductivity material may comprise aluminum nitride. Due to its high electrical resistivity, the resistive heating element heater traces and lead pattern may be screen printed and cured directly on the surface of the electrically insulative aluminum nitride using electrically resistive and electrically conductive thick film inks, respectively.

For the case of either controller design (viz., temperature-sensor based feedback control or resistance feedback control), the number of heater segments distributed over the extent of the first plate of high thermal conductivity material and the corresponding number of independent feedback control channels incorporated in the controller depends on the overall size of the first plate and the magnitude of the differences in the heat dissipation rates across the extent of the first plate used for cooking. The incorporation a first plate of high thermal conductivity material (e.g., oxygen-free hard copper or aluminum type 1100) provides heat conduction across the plane of the first plate so that regions of higher heat dissipation required for cooking receive thermal power [a] by direct heat conduction across the thickness of the first plate from the resistive heating element positioned directly opposite the region of higher heat dissipation and [b] by indirect lateral heat conduction within in the plane of the first plate of high thermal conductivity material from the resistive heating elements located in the regions surrounding said region of higher heat dissipation. If required, two or more independently controlled heater segments may be distributed on the first plate of high thermal conductivity material in order to [a] maintain an acceptably uniform temperature distribution across the extent of larger first plates when operated with regions of higher and lower heat dissipation rates and [b] reduce the time required to heat-up the first plate of high thermal conductivity material from ambient temperature to the user-selected set point temperature.

The side of the first plate of high thermal conductivity material opposite the top cooking surface and containing the flexible substrate heater circuit assembly may be covered with a thermal insulation layer to reduce unwanted heat loss from the side of the first plate that is opposite the top cooking surface. By way of example, a rigid second plate of low thermal conductivity material covers the entire surface of the first plate of high thermal conductivity material on the side opposite the top cooking surface. Said second plate of low thermal conductivity material may be selected from the family of plastic materials including, for example, polyphenylene sulfide, polyamide-imide, polyetherimide, and polyetheretherkeytone offering low thermal conductivity, durability, and capability to withstand continuous operation at temperatures of 200 C or greater. The thermally insulative support plate may be attached to the first plate using an intervening high-temperature gasket material around the perimeter (e.g., silicone gasket) to effect a small gap (e.g., 0.1 to 0.2 inch) between said plates, thereby providing high thermal impedance and low heat loss from the heater side of the first plate due to the very low thermal conductivity of air.

Further disclosed is a method for manufacturing an isothermal cooking plate having first plate portion, heater portion and optional thermal insulation covering over the first plate which comprises the steps:

providing first plate of high thermal conductivity material;

providing flexible substrate heater circuit assembly; and

bonding the flexible substrate heater circuit assembly to the side of first plate opposite the top cooking surface [a] using an electrically insulative and thermally conductive adhesive, if the resistive heating element side is bonded directly to said first plate; or [b] using a thermally conductive adhesive, if the electrically insulative side of flexible substrate heater circuit assembly is bonded directly to said first plate.

An optional second plate of low thermal conductivity material may be applied to the side of the isothermal cooking plate on which the flexible substrate heater circuit assembly is applied.

The disclosure, accordingly, comprises the apparatus, method, and system possessing the construction, combination of elements, arrangement of parts and steps, which are exemplified in the following detailed description.

### BRIEF DESCRIPTION OF THE DRAWINGS

For a fuller understanding of the nature and advantages of the present method and process, reference should be had to the following detailed description taken in connection with the accompanying drawings, in which:

FIG. 1 is a pictorial representation of a two-station griddle comprising two isothermal cooking plate assemblies;

FIG. 1A is a pictorial representation of receptacle for collection of excess oil/fat and cooking debris discharged at right side of griddle system;

FIG. 1B is a top view of bottom surface of first plate with two heater segments adhesively bonded to a single first plate;

FIG. 2 is a detailed sectional view of the isothermal cooking plate assembly comprising first plate of high thermal conductivity material, flexible substrate heater circuit assembly and second plate of low thermal conductivity material illustrating mechanical attachment between first and second plate, front support and rear support pin receiving holes;

FIG. 3A top view of the first type and second type resistive heating elements, leads and electrical contact tabs at either end of heater/lead pattern;

FIG. 3B is an enlarged top view section of one portion of the first type resistive heating element and lead pattern;

FIG. 4 is an enlarged top view section of portion of resistive heating elements, leads and electrical contact tab;

FIG. 5 is a detailed sectional view of portions of isothermal cooking plate assembly showing mechanical lead attachment and temperature sensor location;

FIG. 6 is an enlarged partial view of first plate of high thermal conductivity material and flexible substrate heater circuit assembly showing one embodiment of the attachment of flexible substrate heater circuit assembly to first plate using high-temperature, thermally conductive adhesive;

FIG. 6A is an enlarged partial view of first plate of high thermal conductivity material and flexible substrate heater circuit assembly showing the direct attachment of heating element side of the flexible substrate heater circuit assembly to the first plate using high-temperature thermally insulative and thermally conductive adhesive;

FIG. 7 is a bottom view of second plate of low thermal conductivity material showing rectangular slots for passage of electrical contact lead tabs from flexible substrate heater circuit assembly and threaded holes for mechanical attachment of leads between controller and electrical contact lead tabs;

FIG. 7A is a side view of the second plate in FIG. 7; and

FIGS. 8A-8C combine as labeled thereon to provide a flow chart describing the manufacture and use of isothermal cooking plate as at FIGS. 1, 2, 5, and 6.

The drawings will be described in more detail below.

### DETAILED DESCRIPTION

In the disclosure to follow, initially described is first plate incorporating an aluminum core, which is surmounted by durable non-stick coating on the cooking-surface side. The thermally conductive cooking plat is heated by electrically resistive circuit elements mounted upon a flexible substrate. Preferably, the resistive heating element components and the leads extending thereto as well as the electrical contact tabs are provided on one singular surface of a supporting flexible substrate. This flexible circuit is bonded to first plate blanks with a thermally conductive, electrically insulative adhesive in the case in which the metallic resistive heating element side of the flexible circuit is adhesively bonded directly to the first plate. Alternatively, this flexible circuit is bonded to first plate blanks with a thermally conductive adhesive (which may or may not be electrically insulative) in the case in which the electrically insulative polyimide substrate side of the flexible circuit is adhesively bonded directly to the first plate. The disclosure then turns to the manufacturing techniques employed for the preferred embodiment.

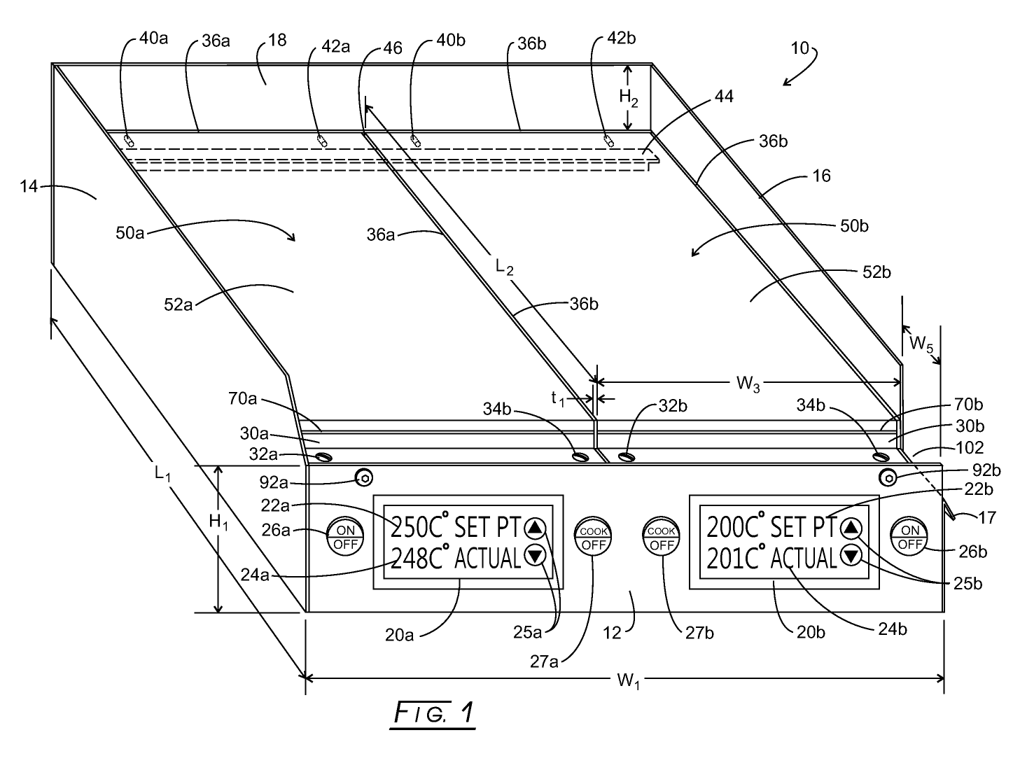

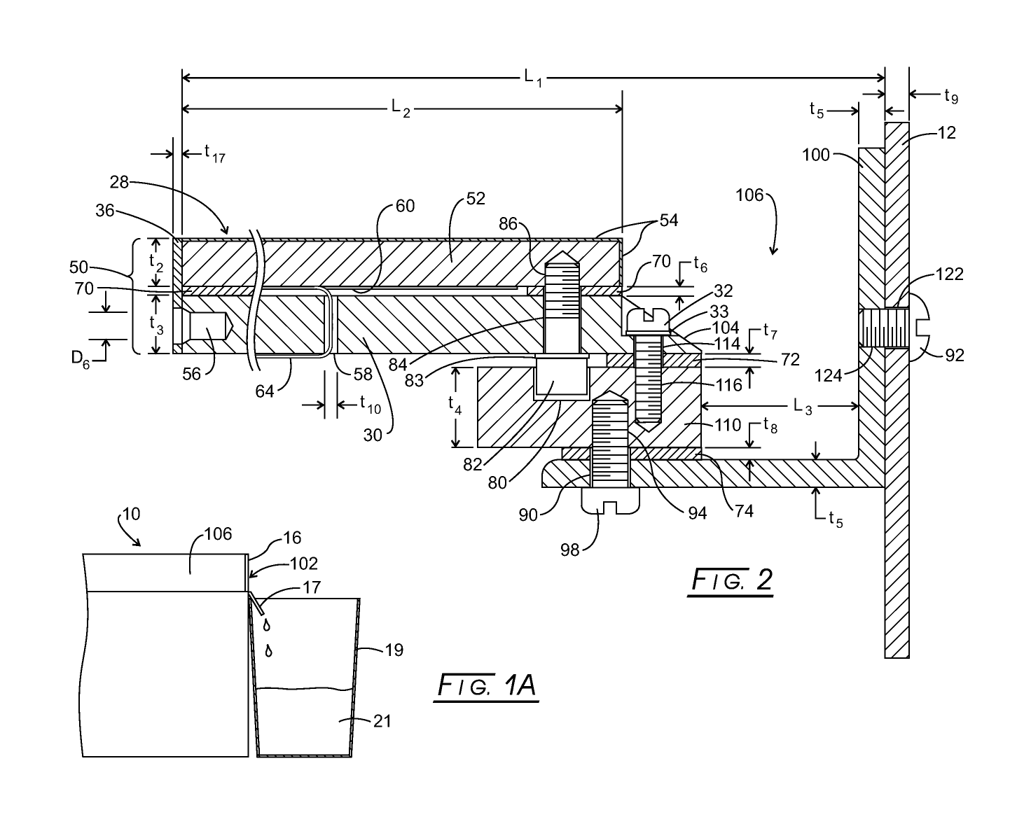

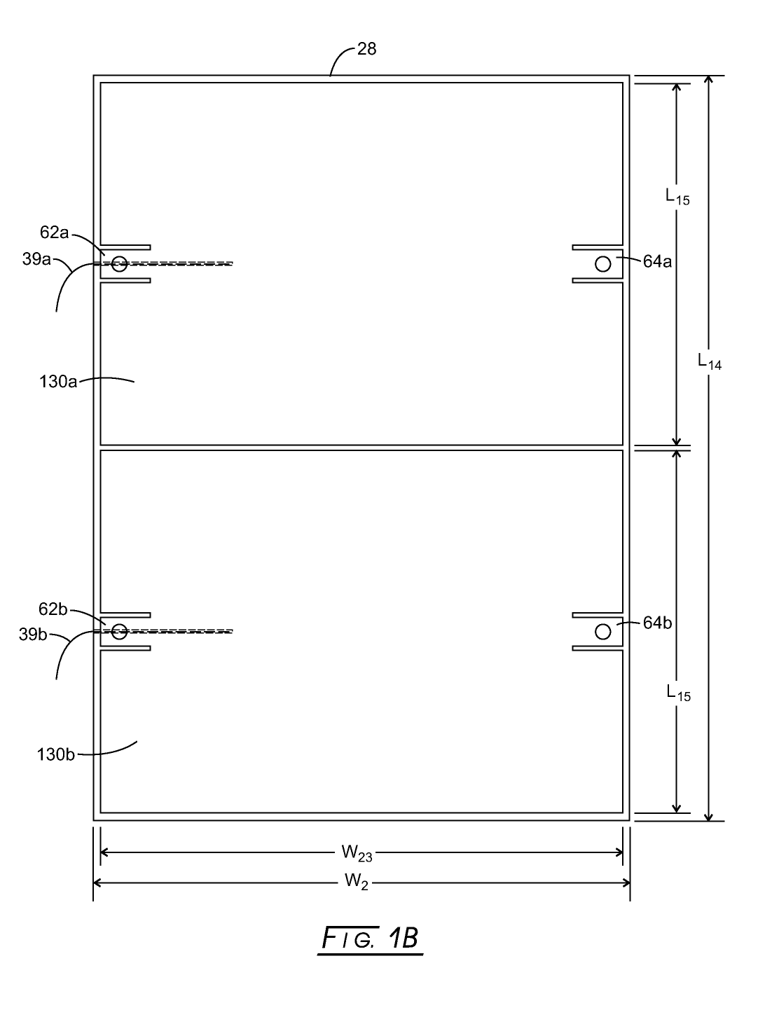

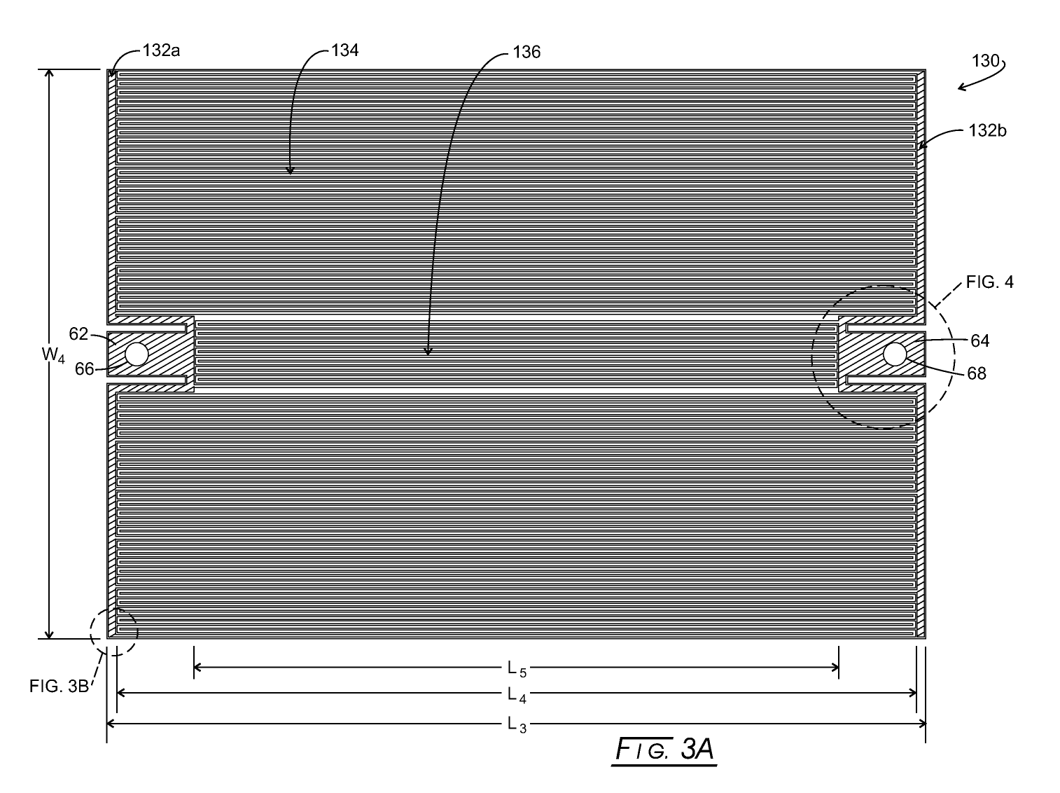

Referring to FIG. 1, a two-station griddle system of the disclosure is represented in general at 10. Griddle system 10 includes isothermal cooking plates 50a, 50b at first and second cooking stations, respectively, comprising first plates 52a, 52b of high thermal conductivity materials surmounted on second plates 30a, 30b of low thermal conductivity material, respectively. The front panel 12, left side panel 14, right side panel 16, and rear panel 18 of enclosure for griddle system 10 may be manufactured using 0.036″-thick austenitic stainless steel Type 304 sheet material available from McMaster-Carr Supply Company (Cleveland, Ohio). A flexible substrate heater circuit assembly 130 (see FIG. 3A) is in thermal communication with and attached to the side opposite of the first plate surfaces (not shown in FIG. 1).

Still referring to FIG. 1, controllers 20a, 20b corresponding to the two stations of the griddle system 10 include set-point up/down selector buttons 25a, 25b as well as set-point displays 22a, 22b and actual first plate temperature displays 24a, 24b. By way of example, a controller 20 for controlling temperature of first plate 52 is available from Omega Engineering, Inc. Model No. CNi8DH (Stamford, Conn.). Controller 20 for controlling temperature of first plate 52 includes solid-state relay to control power applied to flexible substrate heater circuit assembly 130 (not shown). By way of example, a preferred solid-state relay with integral heat sink is Crydon Model No. HS251-D₂₄₅₀ available from Wolf Automation, Inc. (Algonquin, Ill.). Temperature feedback control is provided to controller 20 for controlling temperature of first plate 52 by temperature sensor 38 inserted in temperature sensor well 48 seen in FIG. 5. By way of example, temperature sensor 38 may be a CHROMEL®-ALUMEL® (registered trademarks of Hoskins Alloys, L.L.C., Farmington Hills, Mich.) thermocouple available from Omega Engineering, Inc. (Stamford, Conn.). Alternatively, temperature sensor 38 may be a small-diameter thermocouple (e.g., fabricated using 0.005 inch diameter CHROMEL and ALUMEL thermocouple wire) inserted into a relatively shallow temperature sensor well in the first plate of depth 0.10 to 0.20 inch, diameter of 0.02 to 0.05 inch and secured using a high-temperature thermally conductive adhesive such as EPO-TEK® 930-4 available from Epoxy Technology, Inc. (Billerica, Mass.). This approach to adhesively bonding the temperature sensor directly to the first plate provides temperature feedback control that is more responsive to temperature changes in the first plate than the former unbounded temperature sensor placement method. Also, as seen in FIG. 1, the front panel of griddle system 10 includes controller on/off controls 26a, 26b and on/off power switch for griddle heaters 27a, 27b.

As seen in FIG. 1, rear support 44 is shown in phantom view along with first stabilization pins 40a, 40b and second stabilization pins 42a, 42b machined from austenitic stainless steel Type 304 rod stock with threaded proximal end for mechanical attachment to rear panel 18 of griddle system 10. Rear support 44 may be an austenitic stainless steel Type 304 90-degree angle available from McMaster-Carr Supply Company (Cleveland, Ohio). First and second isothermal cooking plate assembly 50a mechanical fastening screws 40a, 42a are seen at front end of first plate incorporated in first cooking station of griddle system 10. Also, as seen in FIG. 1, first and second isothermal cooking plate assembly 50b mechanical fastening screws 40b, 42b are seen at front end of first plate incorporated in second cooking station of griddle system 10. All mechanical fastening screws identified throughout this specification are preferably fabricated from austenitic stainless steel Type 316 and available from McMaster-Carr Supply Company (Cleveland, Ohio).

Referring to FIGS. 1 and 2, mechanical fastening screws 92a, 92b of diameter D₂ are seen at front panel 12 of griddle system that pass through holes 122 of diameter D₁₀ and into threaded holes 124 mechanically secure front support member 100 to front panel 12. Also, excess liquid and cooking debris discharge opening 102 in the right side panel 16 is shown in FIG. 1 at right end of discharge trough 106 (seen in FIG. 2). A portion of the right side panel 16 is cut and folded down forms ramp 17 that enables the flow of excess oil/fat and cooking debris 21 through excess liquid and cooking debris discharge opening 102 into receptacle 19 as seen in FIG. 1A.

Referring to FIGS. 1 and 2, gap 46 is seen between first-station first plate 52a of high thermal conductivity material and second-station first plate 52b of high thermal conductivity material of high thermal conductivity material is filled with strip of resilient, closed-cell silicone foam in the form of a liquid-tight sealing strip 36a, 36b. Still referring to FIGS. 1 and 2, a strip of resilient, closed-cell silicone foam in the form of a liquid-tight sealing strip 36a, 36b continues around the perimeter of first plate 52a, 52b of high thermal conductivity materials and adjacent second plates 30a, 30b of low thermal conductivity materials to form a liquid-tight seal at the interface between the isothermal cooking plate assembly 50 and the left side panel 14, right side panel 16 and rear panel 18. By way of example, all silicone sealing strips and gaskets referenced throughout this specification may be procured from Stockwell Elastomerics Corporation (Philadelphia, Pa.). Gap 46 provides for the thermal isolation of first-station first plate 52a of high thermal conductivity material and second-station first plate, 52b of high thermal conductivity material so that the first- and second-station first plates can be optionally operated at different set-point temperatures.

Referring now to FIG. 2, the mechanical attachments between the first plate 52 of high thermal conductivity material, second plate 30 of low thermal conductivity material, thermally insulative mounting support 110 and front support member 100 are shown in greater detail.

First plate 52 of high thermal conductivity material may be machined from Type 1100 aluminum plate or oxygen-free hard copper plate, both available from McMaster-Carr Supply Company (Cleveland, Ohio). Second plate 30 of low thermal conductivity material may be injection molded from a plastic material with a high service temperature of at least 150 C. By way of example, second plate 30 of low thermal conductivity material may be injection molded from [a] RYTON® polyphenylene sulfide resin available from Chevron-Phillips Chemical Company (Woodlands, Tex.) or [b] ULTEM® 1000 polyetherimide resin available from Sabic Corporation (Pittsfield, Mass.). By way of example, thermally insulative mounting support member 110 may be machined from DELRIN® (registered trademark of E.I. du Pont de Nemours and Company, Wilmington, Del.) acetal resin bar stock available from McMaster-Carr Supply Company (Cleveland, Ohio).

In a preferred embodiment seen in FIG. 2, the exposed top cooking surface and front edge surface of first plate 52 of high thermal conductivity material are covered with a non-stick coating 54. By way of example, non-stick coating may be selected from polytetrafluoroethylene (PTFE) type coatings such as XYLAN® 8110 supplied by Whitford Corporation (Elverson, Pa.). Alternatively, ceramic, PTFE-free non-stick coatings are available from Thermalon Korea Company, Ltd. In the U.S., THERMALON® (registered trademark of FIPA GmbH Gellschaft mit beschrankter Haftung Fed Rep Germany, Ismanoing, Germany) coating Sol Gel 101 is available from Porcelain Industries (Dickson, Tenn.).

The arrangement of mechanical fastening attachments seen in FIG. 2 provides for the convenient removal of isothermal cooking plate assembly 50 in the event of [a] degradation of the non-stick coating 54, [b] electrical failure of resistive heating element/dielectric substrate flexible substrate heater circuit assembly 130 and/or [c] electrical failure of temperature sensor 38 or 39 (seen in FIGS. 1B and 5).

As seen in FIG. 2, first plate 52 of high thermal conductivity material is mechanically attached to second plate 30 of low thermal conductivity material with mechanical fastening screw 82 of diameter D₃ that passes through hole 84 of diameter D₁₁ in second plate 30 of low thermal conductivity material and into threaded hole 86 in first plate 52 of high thermal conductivity material at a minimum of four locations, preferably at a minimum of at least six locations. The diameter of hole 84 in second plate 30 of low thermal conductivity material is enlarged to accommodate the thermal expansion difference between first plate 52 of high thermal conductivity material operating at elevated set point temperature selected for cooking purposes and lower temperature of second plate 30 of low thermal conductivity material. Also, as seen in FIG. 2, low-friction washer (e.g., polytetrafluorethylene) 83 is positioned between head of mechanical fastening screw 82 and surface of second plate 30 of low thermal conductivity material to enable sliding of mechanical fastening screw 82 relative to second plate 30 of low thermal conductivity material as a result of differential thermal expansion induced forces. By way of example, low-friction polytetrafluoroethylene washers are available from Boker's, Inc. (Minneapolis, Minn.).

A high-temperature gasket 70 (e.g., silicone rubber) is positioned around the perimeter of the interface between the first plate 52 of high thermal conductivity material and the second plate 30 of low thermal conductivity material. A counter bore hole 80 is machined in thermally insulative mounting support member 110 to accommodate head of mechanical fastening screw 82 whose location is offset (to prevent mechanical interference) from the location of mechanical fastening screw 98 of diameter D₅. Thermally insulative mounting support member 110 is securely attached to front support member 100 with mechanical fastening screw 98 that extends through hole 90 of diameter D₁₃ in front support member 100 and into threaded hole 94 in thermally insulative mounting support member 110.

A slot 58 in the second plate 30 of low thermal conductivity material provides for the passage of the electrical contact tab 64 from the flexible substrate heater circuit assembly 130 to a mechanical attachment with the second electrical lead wire 160 (seen in FIG. 5) originating at controller 20b. Mechanical fastening screw 98 secures thermally insulative mounting support 110 to front support member 100. As seen in FIG. 2, liquid-tight barrier strip 74 is located between the base of thermally insulative mounting support 110 and the top surface of front support member 100 to prevent the ingress of liquids into the interior of the griddle system 10. By way or example, liquid-tight barrier strip 74 may be formed from silicone sheet material available from Stockwell Elastomerics Corporation (Philadelphia, Pa.).

Referring to FIG. 2, receiving hole 56 of diameter D₆ is seen at back end of second plate 30 of low thermal conductivity material for engagement with stabilization pin 40 or 42. The combination of the insertion of these stabilization pins 40, 42 into receiving holes 56 at the rear of second plate 30 of low thermal conductivity material and the engagement of mechanical fastening screw 32 of diameter D₄ at the front end of second plate 30 of low thermal conductivity material provide for the removable attachment of the isothermal cooking plate assembly to the griddle system 10. A seen in FIG. 2, mechanical fastening screw 32 passes through hole 114 of diameter D₁₂ in second plate 30 of low thermal conductivity material and into threaded hole 116 in thermally insulative mounting support 110. The diameter of hole 114 in second plate 30 of low thermal conductivity material is enlarged to accommodate the thermal expansion difference between second plate 30 of low thermal conductivity material operating at an elevated temperature and the lower temperature of thermally insulative mounting support 110. Also, as seen in FIG. 2, low-friction washer (e.g., polytetrafluorethylene) 33 is positioned between head of mechanical fastening screw 32 and surface of thermally insulative mounting support 110 to enable sliding of mechanical fastening screw 32 relative to thermally insulative mounting support 110 as a result of differential thermal expansion induced forces. By way of example, low-friction polytetrafluoroethylene washers are available from Boker's, Inc. (Minneapolis, Minn.).

As seen in FIG. 2, liquid-tight barrier strip 72 is located between the base of second plate 30 of low thermal conductivity material and the top surface of thermally insulative mounting support 110 to prevent the ingress of liquids into the interior of the griddle system 10. Also, liquid tight sealing strip 36 is seen at back edge of isothermal cooking plate assembly to prevent ingress of liquids into interior of griddle system. By way or example, liquid-tight barrier strips 36 and 72 may be formed from silicone sheet material available from Stockwell Elastomerics Corporation (Philadelphia, Pa.).

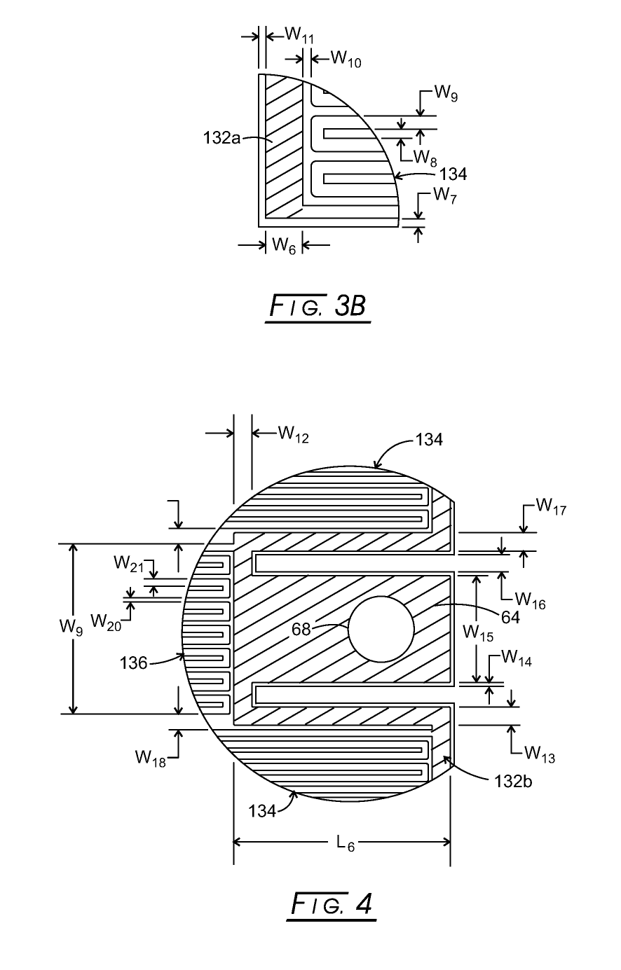

Referring now to FIGS. 3A, 3B, and 4, a top view of flexible substrate heater circuit assembly 130 is seen comprising first type resistive heating element 134 and second type resistive heating element 136 whose number of serpentine lines per heater segment, line widths W₉, W₂₁ and line spacings W₈, W₂₀ are selected to provide substantially equal resistance within each heater segment. The equal resistance among all first type resistive heating elements 134 and second type resistive heating element 136 as well as the uniformity of line widths W₉, W₂₁ and line spacings W₈, W₂₀ within each heater segment enables heating power to be substantially uniform over the entire surface area of flexible substrate heater circuit assembly 130. Electrically conductive buss strips 132a, 132b are seen at either end of first type resistive heating elements 134 and second type resistive heating element 136. As seen in FIG. 3A, there are a total of ten first type resistive heating elements 134 (five above and five below the second type resistive heating element 136) and one second type resistive heating element 136. A single flexible substrate heater circuit assembly 130 as seen in FIG. 3A may be dimensioned so that it substantially covers and is in thermal communication with the entire surface area of the back surface (i.e., side opposite the cooking surface side) of first plate 52a of high thermal conductivity material or 52b of high thermal conductivity material seen in FIG. 1.

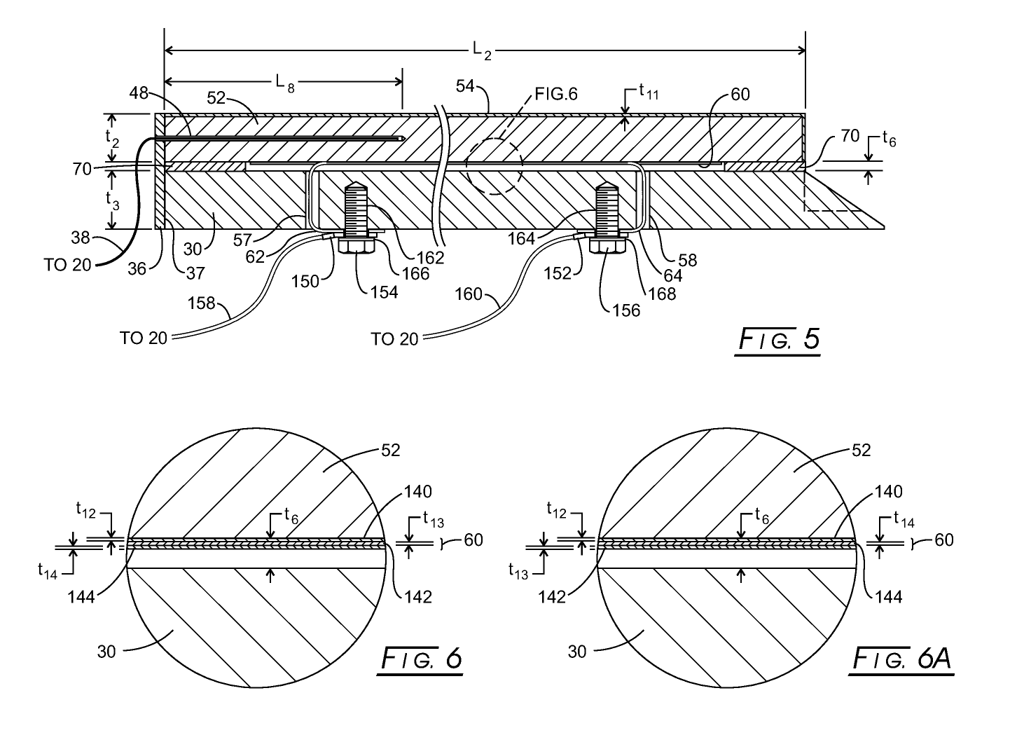

Alternatively, flexible substrate heater circuit assembly 130 may be dimensioned so that two or more independent heater segments are independently distributed so that they substantially cover and are in thermal communication with the entire surface area of the back surface of first plate 52a of high thermal conductivity material or 52b of high thermal conductivity material seen in FIGS. 1 and 1B. Referring to FIGS. 1 and 3A, each of the two or more segments of flexible substrate heater circuit assembly 130 in thermal communication with a single first plate 52a of high thermal conductivity material or 52b of high thermal conductivity material are independently energized and maintained at the user selected set-point temperature by controller 20a or 20b, respectively. By way of example and referring to FIGS. 1, 1B, 3A, and 6, first plate 20a width, W₂ dimension may be 8.00 inches and length, L₁₄ may be 12.00 inches. The flexible substrate heater circuit assembly 130a, 130b segment width, W₂₃ may be 7.96 inches and length, L15 may be 5.96 inches as seen in FIG. 1B. Based on the segmented heater dimensions of this example, two flexible substrate heater circuit assembly 130a, 130b segments would be surmounted side-by-side on a single first plate 52 of high thermal conductivity material using a high-temperature, thermally conductive adhesive 140 (seen in FIG. 6). Separate first set of power leads from controller 20a would be connected to first electrical contact pad 62a and second electrical contact pad 64a of first flexible substrate heater circuit assembly 130a segment and a separate temperature sensor 39a would be placed in thermal communication with the first plate 52 of high thermal conductivity material at a central position of each flexible substrate heater circuit assembly 130 segment as seen in FIG. 1B. Likewise, separate second set of power leads from controller 20a would be connected to first electrical contact pad 62b and second electrical contact pad 64b of second flexible substrate heater circuit assembly 130b segment and a separate temperature sensor 39b would be placed in thermal communication with the first plate 52 of high thermal conductivity material at a central position of each flexible substrate heater circuit assembly 130 segment as seen in FIG. 1B. In the case of the present example, two temperature sensors 39a, 39b would be placed in thermal communication with the first plate 52 of high thermal conductivity material at a perimeter edge of first plate at the mid-point of the width of each flexible substrate heater circuit assembly 130 segment. Several preferred high-temperature, thermally conductive adhesive 140 materials are identified in the description that follows. The thermally conductive adhesive bonding of two or more independently energized and temperature controlled flexible substrate heater circuit assembly 130 segments on to a single first plate 52 of high thermal conductivity material reduces both [a] the time to heat up the first plate from ambient temperature to the user selected set-point temperature and [b] the variation in temperature across the lateral first plate 52 of high thermal conductivity material since temperature control is accomplished based on the measured temperature of each flexible substrate heater circuit assembly 130 segment rather than a single temperature measurement for the entire first plate 52 of high thermal conductivity material.

Still referring to FIGS. 3A, 3B, and 4, the resistive heating element serpentine legs and electrically conductive buss strips 132a, 132b are disposed on an electrically insulative substrate 142 (see FIG. 6). By way of example, electrically insulative substrate 142 may be a flexible polyimide film material of thickness t13 such as KAPTON® available from DuPont (Wilmington, Del.). As seen in FIG. 3A, buss strip 132a terminates in first electrical contact pad 62 and buss strip 132b terminates in second electrical contact pad 64. Buss strips 132a, 132b, first electrical contact pad 62 and second electrical contact pad 64 are copper plated with thickness t₁₅ to minimize electrical resistance and resistive heating in buss and contact pad components. In addition, copper-plated buss components and contact pads are over-plated with gold of thickness t₁₆ to prevent oxidation of copper and reduce electrical contact resistance at interface between contact pads 62, 64 and first or second washer-type electrical contacts 150, 152, respectively as seen in FIG. 5.

Still referring to FIGS. 3A, 3B, and 4, the preferred material for first type resistive heating element 134 and second type resistive heating element 136 is a conductor having a low temperature coefficient of resistance, preferably less than 500 ppm/degree C, more preferably less than 200 ppm/degree C. A low temperature coefficient of resistance of the resistive heating elements 134, 136 allows maximum heating power to be delivered to flexible substrate heater circuit assembly 130 with available fixed line voltages (e.g., 115 volts or 220 volts in the United States) even as the temperature of resistive heating elements 134, 136 increases from room temperature to the maximum set point temperature (e.g., 200 C). One suitable metal alloy exhibiting a low temperature coefficient of resistance is constantan having a low temperature coefficient of resistance of 30 ppm/degree C and available from Hamilton Precision Metals (Lancaster, Pa.). By way of example, first type resistive heating element 134 and second type resistive heating element 136 may formed by first bonding a sheet of constantan of thickness t₁₄ to electrically insulative substrate 142 using a high-temperature polyimide adhesive with setback distances W₇, W₁₁ between the perimeter edges of electrically insulative substrate 142 and constantan sheet. Next, photolithography is used to selectively remove constantan material to form serpentine line widths and line spacings as well as define buss and contact pad components. Finally, portions of photoetched constantan designated to be electrically conductive buss strips 132a, 132b, first contact pad 62 and second contact pad 64 are selectively copper-plated and gold over-plated as described above.

Referring to FIGS. 3A, 4, and 5, holes 66, 68 of diameter D₈ are seen in first electrical contact pad 62 and second electrical contact pad 64, respectively. These holes 66, 68 enable passage of mechanical fastening screws 154 and 156, respectively as seen in FIG. 5.

A preferred arrangement for the removable attachment of first electrical lead wire 158 and second electrical lead wire 160 to first electrical contact pad 62 and second electrical contact pad 64, respectively, is seen in FIG. 5. The proximal ends of first electrical lead wire 158 and second electrical lead wire 160 are electrically connected to solid-state relay at controller 20. By way of example, the distal ends of first electrical lead wire 158 and second electrical lead wire 160 are terminated in first washer-type electrical contact 150 and second washer-type electrical contact 152, respectively. First electrical contact pad 62 and second electrical contact pad 64 traverse across thermally insulative support plate 52 of high thermal conductivity material through first slot 57 and second slot 58, respectively. By way of example, first rectangular slot 57 and second rectangular slot 58 have thickness t₁₀ and length L₇ and extend through full of high thermal conductivity material, thickness of second plate 30 of low thermal conductivity material. Mechanical fastening screws 154, 156 traverse first washer-type electrical contact 150 and second washer-type electrical contact 152 respectively, as well as holes 66, 68 in first electrical contact pad 62 and second electrical contact pad 64, respectively. Mechanical fastening screws 154, 156 are received in threaded holes 162 and 164, respectively. Belleville disc springs 166, 168 of height H₃ and thickness t₁₈, preferably a stack of at least two, preferably four and arranged to maximize deflection distance, are selected having an outside diameter and inside diameter matched to outside diameter, D₉ of mechanical fastening screws 154, 156 and outside diameter of washer-type electrical contacts 150, 152. By way of example, stainless steel Type 302 Belleville disc springs 166, 168 are available from McMaster-Carr Supply Company Supply (Cleveland, Ohio).

The application of torque to mechanical fastening screws 154, 156 induces compression of Belleville disc springs 166, 168 thereby achieving sufficient mechanical contact pressure to minimize electrical contact resistance between first washer-type electrical contact 150 and second washer-type electrical contact 152 and first electrical contact pad 62 and second electrical contact pad 64, respectively. Still referring to FIG. 5, distal end of temperature sensor 38 is seen inserted into temperature sensor well 48 of diameter D₇ and length L₈. High temperature grease may optionally be injected into temperature sensor well 48 to increase response time of temperature sensor 38 to changes in temperature of first plate 52. By way of example, BEL-RAY® 1030 high-temperature silicone grease is available from Bel-Ray Company, Inc. (Farmingdale, N.J.). The proximal end of temperature sensor 38 is connected to controller 20 for controlling temperature of first plate 52 (not shown).

A detailed cross section of composite 60 comprising flexible heater circuit assembly affixed to bottom surface of first plate 52 of high thermal conductivity material is seen in FIG. 6 as referenced in FIG. 5. Referring to FIG. 6, serpentine resistive heating element leg 144 is disposed on electrically insulative substrate 142 and bonded thereto as described above. By way of example, serpentine resistive heating element leg 144 is a low temperature coefficient of resistance metal alloy, such as constantan having thickness t₁₄ and electrically insulative substrate 142 is polyimide film of thickness, t₁₃. As seen in FIG. 6, electrically insulative substrate 142 is adhesively bonded to first plate 52 of high thermal conductivity material using high-temperature adhesive, 140 capable of operating at temperatures of at least 200 C and having thickness, t₁₂. By way of example, high-temperature adhesive 140 may be screen-printed on to first plate 52 of high thermal conductivity material using EPO-TEK® 930-4 available from Epoxy Technology, Inc. (Billerca, Mass.) followed by placement of flexible substrate heater circuit assembly 130 in thermal communication with substantially the entire surface of the back surface of first plate 52 of high thermal conductivity material as seen in FIG. 5. Alternatively, high-temperature adhesive 140 may be screen-printed on to first plate 52 of high thermal conductivity material using Thermasil™ adhesive available from American Standard Circuits, Inc. (West Chicago, Ill.).

As an alternative to the physical arrangement of the serpentine resistive heating element leg 144, electrically insulative substrate 142 and high-temperature adhesive 140 seen in FIG. 6, the thermal impedance between the serpentine resistive heating element leg 144 and the first plate 52 of high thermal conductivity material may be reduced by positioning a high-temperature, electrically insulative adhesive 140 between the serpentine resistive heating element leg 144 and the first plate 52 of high thermal conductivity material without an intervening layer of electrically insulative substrate 142. This alternative arrangement requires the use of an electrically insulative high-temperature adhesive 140 to prevent electrical communication and dielectric breakdown between the serpentine resistive heating element leg 144 and first plate 52.

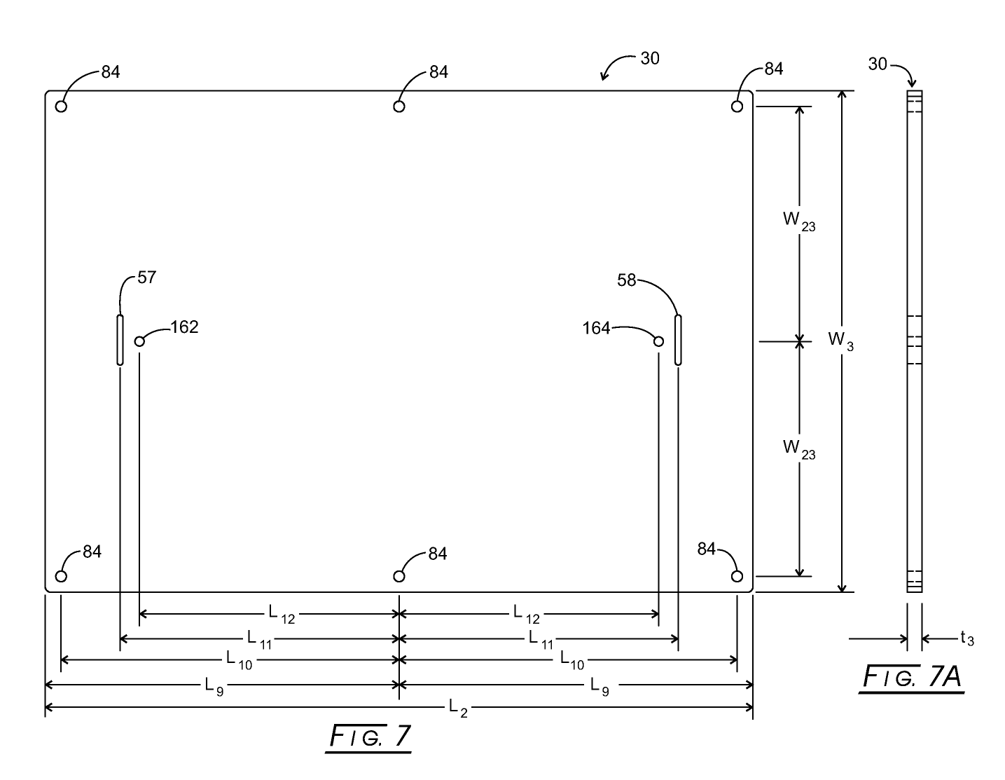

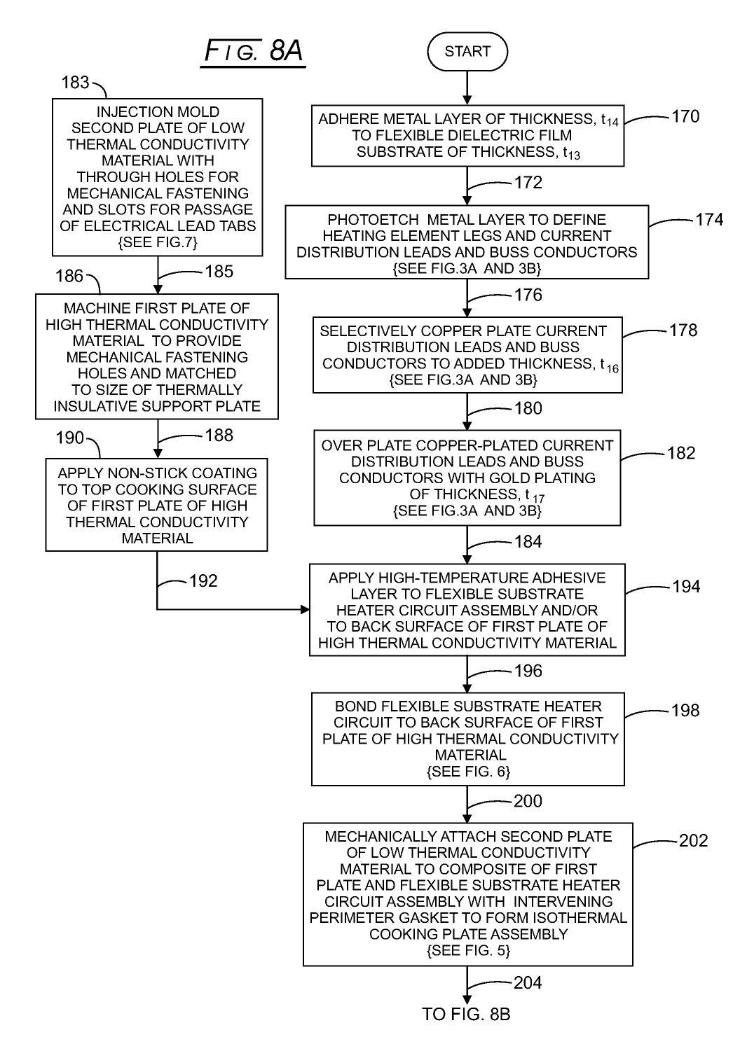

Referring next to FIG. 7, second plate 30 of low thermal conductivity material is seen in both top view and side view providing a specification for the dimensions of the second plate 30 of low thermal conductivity material as well as the location of six holes 84 for passage of mechanical fastening screws 82 that secure first plate 52 of high thermal conductivity material to second plate 30 of low thermal conductivity material. Also, the locations of first threaded hole 162 and second threaded hole 164 seen in FIG. 5 are shown relative to the position of first slot 57 and second slot 58, respectively.

The range of dimensions for the griddle system 10 and its components, as seen in FIGS. 1, 1B, 2, 3A, 3B, 4, 5, 6 and 7 are summarized below in units of inches:

| | |
|---|---|
| L1 = 10.0 to 16.0 | L7 = 0.32 to 0.82 |
| L2 = 8.0 to 16.0 | L8 = 2.0 to 6.0 |
| L3 = 7.9 to 15.9 | L9 = 4.0 to 8.0 |
| L4 = 7.8 to 15.8 | L10 = 3.8 to 7.8 |
| L5 = 5.6 to 14.0 | L11 = 3.0 to 7.0 |
| L6 = 0.5 to 2.5 | L12 = 2.4 to 6.4 |
| W1 = 8 to 54 | W12 = 0.05 to 0.25 |
| W2 = 8.0 | W13 = 0.05 to 0.25 |
| W3 = 6.0 to 12.0 | W14 = 0.01 to 0.04 |
| W4 = 5.8 to 11.9 | W15 = 0.30 to 0.80 |
| W5 = 0.3 to 1.0 | W16 = 0.05 to 0.20 |
| W6 = 0.05 to 0.25 | W17 = 0.05 to 0.25 |
| W7 = 0.01 to 0.03 | W18 = 0.02 to 0.25 |
| W8 = 0.003 to 0.100 | W19 = 0.40 to 1.00 |
| W9 = 0.003 to 0.100 | W20 = 0.003 to 0.100 |
| W10 = 0.01 to 0.03 | W21 = 0.003 to 0.100 |
| W11 = 0.01 to 0.04 | W22 = 0.02 to 0.25 |
| H1 = 4.0 to 10.0 | H3 = 0.012 to 0.030 |
| H2 = 2.0 to 6.0 | |
| D1 = 0.10 to 0.65 | D8 = 0.11 to 0.22 |
| D2 = 0.10 to 0.20 | D9 = 0.10 to 0.20 |
| D3 = 0.10 to 0.20 | D10 = 0.110 to 0.220 |
| D4 = 0.10 to 0.20 | D11 = 0.120 to 0.250 |
| D5 = 0.10 to 0.20 | D12 = 0.120 to 0.250 |
| D6 = 0.10 to 0.20 | D13 = 0.110 to 0.220 |
| D7 = 0.05 to 0.12 | |
| t1 = 0.02 to 0.10 | t10 = 0.02 to 0.08 |
| t2 = 0.12 to 0.37 | t11 = 0.0005 to 0.005 |
| t3 = 0.25 to 0.75 | t12 = 0.001 to 0.010 |
| t4 = 0.25 to 1.00 | t13 = 0.0005 to 0.002 |
| t5 = 0.08 to 0.20 | t14 = 0.0003 to 0.003 |
| t6 = 0.05 to 0.15 | t15 = 0.0005 to 0.003 |
| t7 = 0.05 to 0.15 | t16 = 0.000008 to 0.000020 |
| t8 = 0.05 to 0.15 | t17 = 0.04 to 0.15 |
| t9 = 0.025 to 0.050 | t18 = 0.007 to 0.015 |

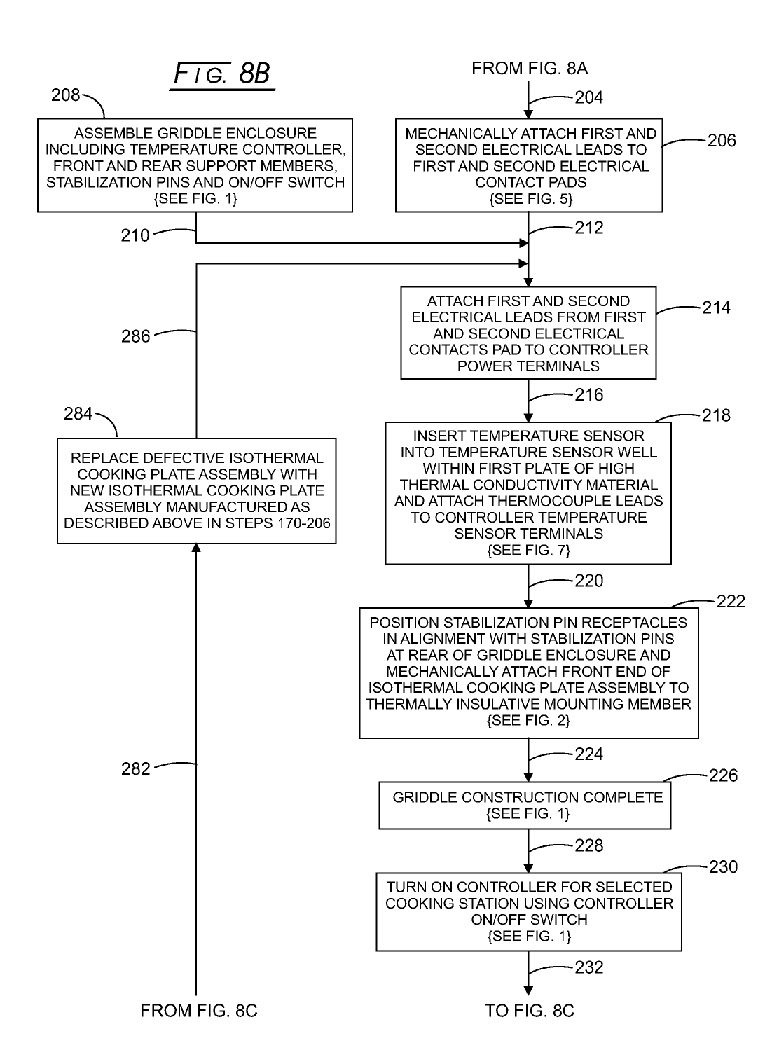

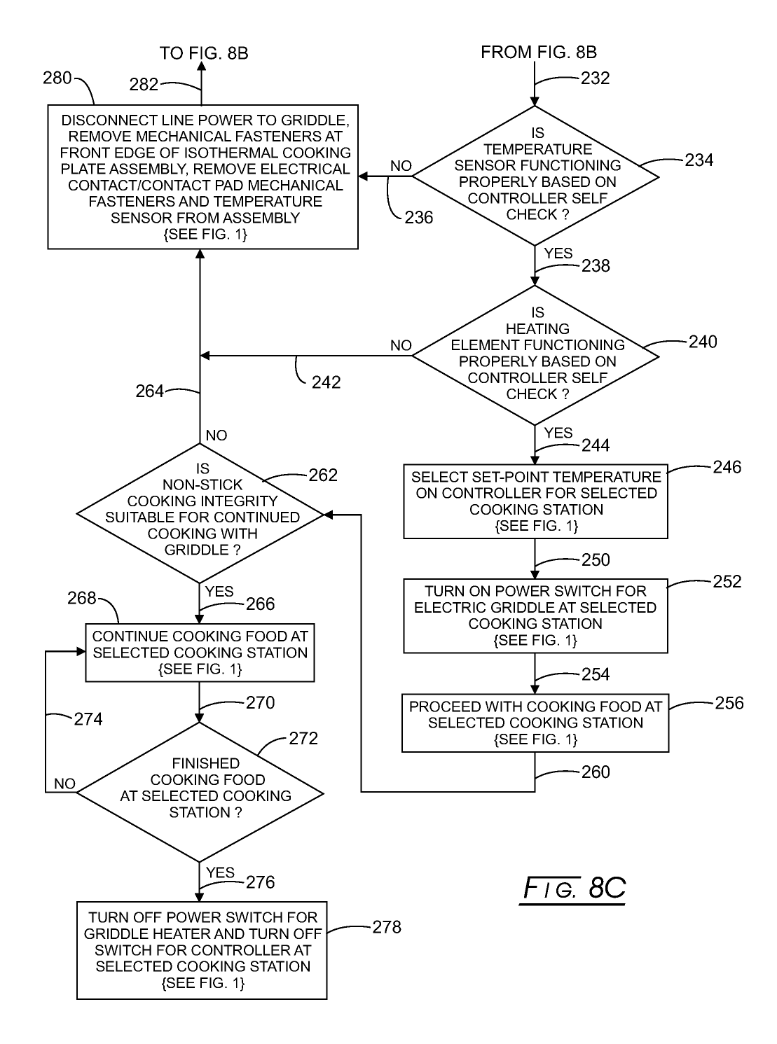

The manufacturing process for constructing the preferred embodiment disclosed in connection with FIGS. 1, 1B, 3A, 3B, and 4-7 as well as the method of use of griddle system 10 are set forth in the flow chart represented in FIGS. 8A-8C. Those figures should be considered as labeled thereon. Looking to FIG. 8A, the procedure commences with adhering metal or metal alloy layer of thickness, t₁₄ to flexible electrically insulative film substrate of thickness, t₁₃ as described at block 170 and arrow 172. Those two materials are a low temperature coefficient of resistance metal alloy (e.g., constantan) and polyimide electrically resistive film substrate. An advantage of the use of a low temperature coefficient of resistance metal alloy is that power delivery to the resistive heater from a line voltage source of fixed voltage level (e.g., 115 volt or 220 volt line voltage sources widely available in the U.S. and 230 volt line voltage source available in most of Europe and United Kingdom) remains substantially constant as the resistive heating element temperature increases from ambient temperature to the user selected set point temperature (e.g., 200 C). The process of adhering metal or metal alloy layer to flexible electrically insulative film substrate can be accomplished with the use of high temperature adhesive (e.g., polyimide adhesive). The metal or metal alloy adhered to flexible electrically insulative film substrate is next photo etched using photolithography to define the resistive heating element serpentine legs and current distribution leads as illustrated in FIGS. 3A, 3B, and 4 as identified in block 174 and arrow 172. Once the resistive heating element serpentine legs and current distribution leads have been defined, the lead (also referred to a buss) portions are selectively plated with copper to minimize resistance in the leads using a copper plating thickness, t₁₆ as identified in block 178 and arrow 176. In order to minimize oxidation of copper plating leads as well as minimize electrical contact resistance between the lead tab portion and the abutting washer-type electrical contact as seen in FIG. 5, Copper-plated leads are over plated with a gold layer of thickness, t₁₇ as identified at block 182 and arrow 180.

In preparation for the fabrication of the isothermal cooking plate assembly, the thermally insulative support plate is injection molded with [a] through holes for mechanical fastening screw used to attach thermally insulative support plate to first plate and [b] slots for passage of electrical contact tabs from heater to bottom surface of thermally insulative support plate to enable electrical contact with washer-type electrical lead contact as seen in FIG. 5 and identified in block 183 and arrow 185. By way of example, injection-molding resins may advantageously include polyetherimide or polyphenylene sulfide from sources identified in a preceding section of this specification. The two holes adjacent to the two slots may advantageously be sized to receive press-in, flanged-head threaded inserts thereby eliminating the need for post-injection molding machining processes. By way of example, press-in, flanged-head threaded inserts are manufactured by Penn Engineering and available through D. B. Roberts Company (Highland Heights, Ohio). The fabrication of the thermally insulative support plate using only injection molding processes provides the advantage of minimizing the cost of this component and, thereby, minimizing the overall cost of the replaceable isothermal cooking plate subassembly.

The first plate is machined to match the dimensions of the thermally insulative support plate with threaded holes located to match through holes in the thermally insulative support plate as identified in block 186 and arrow 188. By way of example, the first plate may be machined from aluminum Type 1100 or oxygen-free hard copper. A non-stick coating may optionally be applied to top surface and side edges of first plate as identified in block 190 and 192. The use of a non-stick coating on the cooking surface serves to minimize adherence of food to the first plate surface during cooking process as well as minimize the need for additional cooking oils and fats during the cooking process. Alternative high-temperature non-stick coatings include polytetrafluoroethylene as well as ceramic non-stick coatings. A preferred embodiment of the griddle system of the present disclosure incorporates the use of a non-stick coating. A particular advantage of the griddle system of the present disclosure is the ability to replace the relatively low-cost isothermal cooking plate subassembly at such time as the non-stick coating release characteristic degrades following extended cooking use or as a result of an electrical failure within the resistive heating element.

Still referring to FIG. 8A, a high-temperature adhesive layer is next applied to back surface of first plate in preparation for bonding the resistive heating element/electrically insulative film substrate subassembly to the first plate as seen in FIG. 6 and identified in block 194 and arrow 196. The next step involves the bonding of the resistive heating element/electrically insulative film substrate subassembly to the first plate as identified in block 198 and arrow 200. One possible arrangement of the resistive heating element, electrically insulative film substrate and high-temperature adhesive is seen in FIG. 6 wherein the electrically insulative film substrate is disposed between the resistive heating element and the adhesive layer. An alternative arrangement may advantageously position the resistive heating element directly in contact with an electrically insulative, high-temperature adhesive and thereby reduce the thermal impedance between the resistive heating element and the first plate since heat conduction through the electrically insulative film substrate is avoided. As a consequence, the time required to increase the temperature of the first plate from ambient temperature to the user selected set-point temperature is reduced. Accordingly, the waiting time from the start of energizing the heater to the time when cooking can commence is likewise reduced. By way of example, high-temperature, electrically insulative adhesives include EPO-TEK® 930-4 available from Epoxy Technologies (Billerica, Mass.) and THERMASIL® available from American Standard Circuits (West Chicago, Ill.).

Referring now to FIG. 8B, the first plate/heater subassembly completed in block 198 is next mechanically attached to thermally insulative support plate with an intervening gasket (e.g., silicone rubber) of thickness t₆ around the perimeter of the interface between the first plate and the thermally insulative support plate as seen in FIG. 2 and identified in block 202 and arrow 204. The intervening perimeter gasket of thickness t₆ results in an air gap between the first plate and the thermally insulative support plate. This air gap of thickness t₆, combined with the low thermal conductivity of the plastic material selected for the thermally insulative support plate, serves to minimize heat losses from the back surface of the first plate (i.e., the side opposite the cooking surface) and thereby increase the overall efficiency of the griddle system during use. In addition, based on a preferred embodiment of the present disclosure, reducing the elapsed time for heating up a griddle to cooking temperature level from 10 to 20 minutes to about 15 to 30 seconds for heating up a griddle to cooking temperature level enables the griddle system of the present disclosure to be turned off between uses, thereby eliminating power consumption during idle periods during which no cooking is being performed. The combination of [a] the reduced heat and associated power losses during the cooking period through the incorporation of a thermally insulative support plate and thermally insulative air gap in the griddle system and [b] the capability to turn off electrical power to the first plate between uses enables the achievement of a high efficiency level since minimal heating power is required and only during the actual cooking period.

Still referring to FIG. 8B, griddle enclosure is assembled as identified in block 208 and arrow 210 and includes [a] support members for isothermal cooking plate located along the interior of front and rear griddle enclosure panels, [b] stabilization pins located on rear panel of griddle enclosure, [c] one or more controller/solid state relay unit and associated power switch corresponding to the number of cooking stations and [d] one or more heater power switches corresponding to the number of cooking stations as seen in FIGS. 1 and 2. The next assembly step involves the mechanical attachment of the distal ends of first and second electrical leads to first and second electrical contact pads as seen in FIG. 5 and as identified at block 206 and arrow 212. Next, the proximal ends of first and second electrical leads are attached to each controller/solid state relay unit as identified at block 214 and arrow 216. Next, insert temperature sensor into temperature sensor well located in first plate as seen in FIG. 5 and attach proximal ends of temperature sensor leads to controller as identified at block 218 and arrow 220. Finally, align stabilization pin receptacle holes in thermally insulative support plate with stabilization pins affixed to rear panel of griddle enclosure and translate thermally insulative support plate towards rear panel of griddle enclosure so that stabilization pins enter and engage stabilization pin receptacle holes. Next, align holes at front end of thermally insulative support plate with threaded holes in thermally insulative mounting support and complete attachment of thermally insulative support plate using mechanical fasteners as seen in FIG. 2 and as identified in block 222 and arrow 224. Having completed this last step, the assembly of the griddle system is complete as seen in FIG. 1 and as identified in block 226 and arrow 252.

Referring now to FIG. 8C, the next sequence of steps refer to operation of the griddle system for the purpose of cooking food. The first step in the use of a selected station of the griddle system is to turn on the controller using the controller on/off switch as identified at block 230. As represented at arrow 232 and block 234, an electrical test is automatically performed by the controller to determine if the temperature sensor is functioning properly. In the event the temperature sensor is not functioning properly, a visual cue will be displayed and it will be necessary to detach the isothermal cooking plate assembly from the front and rear supports within the griddle assembly so that temperature sensor can be replaced as identified in prior block 218 and arrow 220. Following replacement of the temperature sensor, the isothermal cooking plate assembly can be reattached to the front and rear panels of griddle system as identified in prior block 222 and arrow 224. Still referring now to FIG. 8C, the next step after temperature sensor replacement is to turn on the controller using the controller on/off switch as identified at block 230. As represented at arrow 232 and block 234, an electrical test is again automatically performed by controller to determine if the new temperature sensor is functioning properly. In the event the new temperature sensor or, on the other hand, the original temperature sensor is functioning properly, the operation of the griddle systems proceeds to the next step as identified by arrow 238 and block 240. In block 240, an electrical test is automatically performed by controller to determine if the resistive heating element resistance is within a predetermined acceptable range. If the resistive heating element resistance is not within a predetermined acceptable range, a visual cue will be displayed at it will be necessary to detach the isothermal cooking plate assembly from the front and rear supports within the griddle assembly so that a new isothermal cooking plate assembly replaces the defective isothermal cooking plate assembly by returning to block 206 following path indicated by arrow 242 and repeating sequential steps as represented in blocks 206, 214, 218 and 222. On the other hand, if resistive heating element resistance is within a predetermined acceptable range, then the operation of the griddle system proceeds to the next step as identified by block 240 and arrow 244.

Still referring to FIG. 8C, the next step in the operation of the griddle system is the selection of the set-point temperature by the user and display of the set-point temperature by the controller as illustrated in FIG. 1 and as represented by block 246 and arrow 250. Next, upon the intended start of cooking at selected station of griddle system, operator turns on power to heater at selected station and waits about 15 to 30 seconds for first plate to heat up to selected set-point temperature as indicated by display on controller seen in FIG. 1 and as identified by block 252 of high thermal conductivity material and arrow 254. Once the first plate temperature reaches the user selected set-point temperature, cooking commences as identified in block 256 and 260. During or after the period of cooking, the user visually inspects the non-stick coating, if used, on the surface of the first plate as identified by block 262. If the integrity of the non-stick coating is unsuitable for continued cooking then it will be necessary to detach the isothermal cooking plate assembly from the front and rear supports within the griddle assembly so that a new isothermal cooking plate assembly replaces the defective isothermal cooking plate assembly by returning to block 206 following path indicated by arrow 242 and repeating sequential steps as represented in blocks 206, 214, 218 and 222. On the other hand, if the integrity of the non-stick coating is suitable for continued cooking, then cooking may continue as seen in arrow 266 leading to block 268. The user next decides if cooking at selected station of griddle system has been completed as identified at block 272. If cooking has not been completed, continue cooking as identified by arrow 274 and block 268. On the other hand, if cooking has been completed, turn off power switch to griddle heater and power switch to controller as seen in FIG. 1 and as identified at block 278.

### Example

A computer-based transient thermal analysis of alternative isothermal cooking plate assemblies was performed using the TRUMP finite-differencing method (see Edwards, Arthur L., “TRUMP: A Computer Program for Transient and Steady State Temperature Distributions in Multi Dimensional Systems”, Lawrence Livermore Laboratory, Livermore Calif.; Report No. UCRL-14754, Rev. 3, Sep. 1, 1972: 1-267). The fixed parameters using in the transient thermal analysis are listed below corresponding to a preferred embodiment of the isothermal cooking plate assembly comprising the first plate of high thermal conductivity material, flexible substrate heater circuit assembly and thermally conductive, electrically insulative adhesive used to achieve thermal conduction heat transfer between the flexible substrate heater circuit assembly and the first plate. The heat losses from the isothermal cooking plate assembly were neglected during the rapid heat-up period due to their relatively small size relative to the heat being delivered to the first plate during its heat up (i.e., non-cooking) phase and the thermally insulative effect of the air boundary surrounding the top cooking surface of the first plate as well as the air boundary surrounding the exposed back surface of the flexible circuit heating element assembly.

By way of example, the high-temperature thermally conductive, electrically insulative adhesive properties assumed for these transient thermal analyses was based on the EPO-TEK® 930-4 adhesive available from Epoxy Technologies, Inc. (Billerica, Mass.). Also, by way of example, the heating element material assumed for these transient thermal analyses was based on a constantan alloy, which enables the delivery of a constant heating rate at an applied fixed line voltage of either 115 volts or 220 volts at a maximum current of 20 amps and 21 amps, respectively, during the heat up period. The design of the first plate of high thermal conductivity material optimized to [a] provide a cooking station having a size practical for cooking, [b] provide lateral thermal conductance sufficiently high to maintain the temperature of the extent of the cooking surface of the first plate within about 10 degrees of the set-point temperature under all anticipated cooking conditions, and [c] provide a total heat capacity sufficiently low to enable rapid heat-up from 25 C to the user-selected set-point temperature. A preferred embodiment of the present invention comprises a first plate of aluminum Type 1100 having [a] an overall cooking surface size of 8.15 inches×12.00 inches and [b] a thickness of 0.190 inches.

The variable parameters used in these transient thermal analyses are summarized in the table below along with the principal results of the analyses. A total of six cases are presented in the table. The first three cases correspond to adhesive bonding of the heater circuit to the back surface of the first plate using an adhesive layer thickness of 0.002 inch wherein the polyimide substrate layer is interposed between the heater circuit and the adhesive layer (see FIG. 6). The second three cases correspond to adhesive bonding of the heater circuit directly to the back surface of the first plate using an adhesive layer thickness of 0.005 inch wherein the polyimide substrate layer is not interposed between the heater circuit and the adhesive layer (see FIG. 6A). As seen in the table, Case 1 and 4 correspond to an isothermal cooking plate assembly wherein the line voltage supply is 115 volts and the maximum current during heat up is 20 amps resulting in a maximum power delivery of 2300 watts to the 8.15″×12.00″ size first plate using only a single flexible substrate heater circuit assembly that substantially matches the size of the size of the first plate. As seen in the table below, the computed elapsed time for the first plate to heat up from 25 C to 150 C (i.e., a example set-point temperature for cooking) is 40.6 seconds for both Cases 1 and 4. The maximum computed temperature rise of the heating element above the temperature of the first plate during the heat-up period is 17.7 C and 5.6 C for Case 1 and Case 4, respectively. Case 1 corresponds to the polyimide layer interposed between the heater circuit and the adhesive layer (see FIG. 6), whereas Case 4 corresponds to the heating element in direct contact with the adhesive layer such that the polyimide layer is not interposed between heater circuit and the first plate (see FIG. 6A).

As seen in the table, Case 2 and 5 correspond to an isothermal cooking plate assembly wherein the line voltage supply is 220 volts and the maximum current during heat up is 21 amps resulting in a maximum power delivery of 4,620 watts to the 8.15″×12.00″ size first plate using only a single flexible substrate heater circuit assembly that substantially matches the size of the size of the first plate. As seen in the table below, the computed elapsed time for the first plate to heat up from 25 C to 150 C (i.e., a example set-point temperature for cooking) is 20.2 seconds for both Cases 2 and 5. The maximum computed temperature rise of the heating element above the temperature of the first plate during the heat-up period is 35.5 C and 11.2 C for Case 2 and Case 5, respectively. Case 2 corresponds to the polyimide layer interposed between the heater circuit and the adhesive layer (see FIG. 6), whereas Case 5 corresponds to the heating element in direct contact with the adhesive layer such that the polyimide layer is not interposed between heater circuit and the first plate (see FIG. 6A).

As seen in the table, Case 3 and 6 correspond to an isothermal cooking plate assembly wherein the line voltage supply is 115 volts and the maximum current during heat up is 20 amps resulting in a maximum power delivery of 4,620 watts to the 8.15″×12.00″ size first plate using two side-by-side flexible substrate heater circuit assemblies that combine to substantially match the size of the size of the first plate as seen in FIG. 1B. As seen in the table below, the computed elapsed time for the first plate to heat up from 25 C to 150 C (i.e., a example set-point temperature for cooking) is 20.3 seconds for both Cases 3 and 6. The maximum computed temperature rise of the heating element above the temperature of the first plate during the heat-up period is 35.4 C and 11.2 C for Case 3 and Case 6, respectively. Case 3 corresponds to the polyimide layer interposed between the heater circuit and the adhesive layer (see FIG. 6) whereas Case 6 corresponds to the heating element in direct contact with the adhesive layer such that the polyimide layer is not interposed between heater circuit and the first plate (see FIG. 6A).

Based on the results of the transient thermal analyses presented in the table below, shorter required durations for the heat-up from 25 C to 150 C can be reduced by a two-fold factor by either [a] using a line voltage of 220 volts and maximum current of 21 amps or [b] affixing two flexible substrate heater circuit assemblies operating at a line voltage of 115 volts and current of 20 amps. Also, as seen in the table below, the maximum temperature rise of the heating element above the temperature of the first plate during the heat-up period can be reduced by a factor of over three, from 35.5 C to 11.2 C, by applying a thicker layer of the high-temperature, thermally conductive, electrically resistive adhesive directly between the heating element and the first plate. For the case of higher cooking set point temperatures, the elapsed time for the first plate to reach a higher set-point temperature is correspondingly higher. By way of example, the elapsed time for the first plate to increase from 25 C to a higher set-point temperature of 200 C is calculated to be 28.3 seconds for both Case 5 and Case 6.

In the case of griddle applications for which it is desirable for the heat-up time to the set-point temperature to be as short as possible, a preferred embodiment of the present disclosure is represented by Case 6 or Case 7 in the table presented below. As specified above, Case 6 corresponds to an aluminum Type 1100 first plate measuring 8.15 inch×12.00 inch×0.190 inch thick heated by a single flexible substrate heater circuit assembly at a line voltage of 220 volts having an area substantially the same as the first plate and using a high-temperature thermally conductive, electrically insulative adhesive between the heater circuit and the first plate without an interposing layer of polyimide. As specified above, Case 7 corresponds to an aluminum Type 1100 first plate measuring 8.15 inch×12.00 inch×0.190 inch thick heated by a two flexible substrate heater circuit assembly at a line voltage of 115 volts having an area substantially the same as the first plate and using a high-temperature thermally conductive, electrically insulative adhesive between the heater circuit and the first plate without an interposing layer of polyimide.

Fixed Parameters Used in Transient Thermal Analyses:

1. Specific heat of Polyimide flexible substrate: 0.261 cal/gram-C
2. Thermal conductivity-Polyimide flexible substrate: 0.0012 watts/cm-C
3. Density of Polyimide flexible substrate: 1.420 grams/cubic cm.
4. Specific heat of Epo-Tek 930-4 adhesive: 0.36 cal/gram-C
5. Density of Epo-Tek 930-4 adhesive: 0.980 grams/cubic cm.
6. Thermal conductivity of Epo-Tek 930-4 adhesive: 0.0167 watts/cm-C
7. Thickness of Polyimide flexible substrate: 0.00254 cm (0.001 inch)
8. Initial temperature of Griddle Plate: 25 C
9. Specific heat of Aluminum 1100: 0.216 cal/gram-C
10. Thermal conductivity of Aluminum 1100: 2.18 watts/cm-C
11. Density of Aluminum 1100: 2.71 grams/cubic cm.

### 12. Size of First Plate (Cooking Surface Size): 8.15″×12.00″

Variable Parameters Used in Transient Thermal Analyses and Results

| | Number of | | Adhe- | Elapsed | Maximum Temp. |
|---|---|---|---|---|---|
| | Flexible | Max- | sive | Time for | Rise of Heating |
| | Substrate | imum | Layer | First Plate | Element above |
| | Heater Circuit | Heater | Thick- | To Reach | First Plate dur- |
| Case | Assemblies per | Power | ness | 150 C. | ing Heat Up |
| No. | First Plate | [watts] | [inch] | [seconds] | [C.] |
| | {See FIG. 6} | | | | |
| 1 | 1 | 2300 | 0.002 | 40.6 | 17.7 |
| 2 | 1 | 4620 | 0.002 | 20.2 | 35.5 |
| 3 | 2 | 4600 | 0.002 | 20.3 | 35.4 |
| | {See FIG. 6A} | | | | |
| 4 | 1 | 2300 | 0.005 | 40.6 | 5.6 |
| 5 | 1 | 4620 | 0.005 | 20.2 | 11.2 |
| 6 | 2 | 4600 | 0.005 | 20.3 | 11.2 |

While the apparatus, method, and system have been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the disclosure not be limited to the particular embodiments disclosed, but that the disclosure will include all embodiments falling within the scope of the appended claims. All citations referred herein are expressly incorporated herein by reference.

I claim:

1. An isothermal cooking plate assembly comprising:
(a) a first plate of high thermal conductivity material having a back surface and an oppositely disposed top cooking surface;
(b) one or more heater circuit assemblies disposed on the first plate back surface for forming a composite having a back surface; and
(c) a controller in electrical connection with said one or more heater circuit assemblies for controlling temperature of said first plate of high thermal conductivity material.

2. The isothermal cooking plate assembly of claim 1, wherein said first plate comprises substantially pure one or more aluminum, substantially pure copper, or aluminum nitride.

3. The isothermal cooking plate assembly of claim 1, wherein the first plate comprises a laminate comprising a clad bottom metal layer and clad top cooking surface metal layer, said clad layers formed from the same material and having about the same thickness.

4. The isothermal cooking plate assembly of claim 3, wherein said clad material comprises austenitic stainless steel.

5. The isothermal cooking plate assembly of claim 1, wherein a second plate of low thermal conductivity material is attached to the composite back surface.

6. The isothermal cooking plate assembly of claim 5, wherein an air layer is present between said first plate and said composite back surface.

7. The isothermal cooking plate assembly of claim 1, wherein said top cooking surface of said first plate is coated with a layer of non-stick material.

8. The isothermal cooking plate assembly of claim 1, wherein said one or more heater circuit assemblies are independently controllable by said controller.

9. The isothermal cooking plate assembly of claim 1, wherein said controller includes feedback control.

10. A method of manufacturing the isothermal cooking plate assembly of claim 1, which comprises the steps of:
(a) providing a first plate of a high thermal conductivity material having a top cooking surface and an oppositely disposed back surface;
(b1) affixing heating circuits on said first plate back surface by:
(i) depositing a first electrically insulative layer on the first plate if the first plate is metallic;
(ii) depositing a second electrically resistive heating element layer on the first plate back surface or on the first electrically insulative layer; and
(iii) depositing a third electrically conductive lead and contact pad layer in electrical communication with the electrically resistive heating element; or
(b2) affixing heating circuits on said first plate back surface by:
(i) depositing first electrically resistive heating element layer on first plate if first plate is electrically insulative; and
(ii) depositing second electrically conductive lead and contact pad layer in electrical communication with electrically resistive heating element; or
(b3) affixing heating circuits on said first plate back surface by:
(i) affixing heating circuits on the plate back surface using high-temperature, electrically resistive, thermally conductive adhesive, said heating circuit comprising a flexible substrate heater circuit assembly.

11. The isothermal cooking plate assembly of claim 1, wherein the resistive heating element is a material having a temperature coefficient electrical resistance of less than 500 parts per million per degree.

12. An isothermal laminate cooking plate assembly comprising:
(a) a first plate of high thermal conductivity material having a back surface and an oppositely disposed top cooking surface;
(b) one or more flexible substrate heater circuit assemblies affixed to the first plate back surface of for forming a composite;
(c) a second plate of low thermal conductivity material attached to the composite back surface;
(d) a controller in electrical connection with said one or more flexible substrate heater circuit assemblies for controlling temperature of said first plate of high thermal conductivity material,
wherein said first layer plate thickness and area are selected to enable heat-up from about 25 C to about 150 C within:
(i) about 40 seconds using applied voltage of 115 volts and maximum current of 20 amps for a single flexible substrate heating circuit assembly substantially covering the first plate back surface; or
(ii) about 20 seconds using applied voltage of 220 volts and maximum current of 21 amps for a single flexible substrate heating circuit assembly substantially covering the first plate back surface; or
(iii) about 20 seconds using applied voltage of 115 volts and maximum current of 20 amps for two side-by-side flexible substrate heating circuit assemblies substantially covering the first plate back surface.

13. The isothermal laminate cooking plate assembly of claim 12, wherein said first plate comprises substantially pure aluminum, substantially pure copper, or aluminum nitride.

14. The isothermal cooking plate assembly of claim 12, wherein the first plate comprises a laminate comprising a clad bottom metal layer and clad top cooking surface metal layer, said clad layers formed from the same material and having about the same thickness.

15. The isothermal laminate cooking plate assembly of claim 14, wherein said clad material comprises austenitic stainless steel.

16. The isothermal laminate cooking plate assembly of claim 12, wherein said top cooking surface of plate metal layer is coated with a layer of non-stick material.

17. The isothermal laminate cooking plate assembly of claim 12, wherein said one or more flexible substrate heater circuit assemblies are independently controllable by said controller.

18. The isothermal laminate cooking plate assembly of claim 12, wherein said controller includes feedback control.

19. The isothermal laminate cooking plate assembly of claim 12, wherein an air layer is present between said first plate and said back surface of composite of said first plate and said one or more heater circuit assemblies.

20. The isothermal laminate cooking plate assembly of claim 12 wherein the resistive heating element is a metal alloy having a temperature coefficient electrical resistance of less than 500 parts per million per degree C.

21. An electric griddle comprising one or more isothermal cooking plate assemblies in which each isothermal cooking plate assembly comprises:
(a) a first plate of high thermal conductivity material having a back surface and an oppositely disposed top cooking surface;
(b) one or more flexible substrate heater circuit assemblies affixed to said first plate back surface for forming a composite having a back surface;
(c) a second plate of low thermal conductivity material attached to the composite back surface; and
(d) a controller in electrical connection with said one or more flexible substrate heater circuit assemblies for controlling temperature of said first plate of high thermal conductivity material,
whereby said isothermal cooking plate assembly is readily replaceable.

22. The electric griddle of claim 21, wherein said first plate comprises substantially pure aluminum, substantially pure copper, or aluminum nitride.

23. The electric griddle of claim 21, wherein the first plate is a laminate comprising a clad metal bottom layer and clad metal top cooking surface layer bonded to the first plate, said clad layers formed from the same material and having about the same thickness.

24. The electric griddle of claim 22, wherein said clad material comprises austenitic stainless steel.

25. The electric griddle of claim 21, wherein an air layer is present between said first plate and the second plate.

26. The griddle system of claim 21, wherein said first plate top cooking surface is coated with a layer of non-stick material.

27. The electric griddle of claim 21, wherein said one or more flexible substrate heater circuit assemblies are independently controllable by said controller.

28. The electric griddle of claim 21, wherein said controller includes feedback control.

29. A method of manufacturing the isothermal cooking plate assembly of claim 21, which comprises the steps of:
(a) providing a first plate of a high thermal conductivity material having a top cooking surface and an oppositely disposed back surface;
(b) providing one or more flexible substrate heating circuits; and
(c) bonding one or more flexible substrate heating circuits to said first plate back surface:
(i) using an electrically insulative and thermally conductive adhesive if the heating element is bonded directly to the first plate back surface of said first plate; or
(ii) using a thermally conductive adhesive if the electrically insulative flexible the first plate back surface; and
(iii) attaching a second plate of low thermal conductivity material to the first plate back surface on which the one or more flexible substrate heating circuits heating circuits are affixed.

30. The electric griddle of claim 21, wherein the isothermal cooking plate assembly is attached to griddle using only mechanical fasteners to enable field replaceable isothermal cooking plate assembly.

31. The one or more flexible substrate heater circuit assemblies of claim 21, wherein the resistive heating element is a metal alloy having a temperature coefficient electrical resistance of less than 500 parts per million per degree C.
